(19) United States
(12) Patent Application Publication
(10) Pub. No.: US 2023/0282470 A1
(43) Pub. Date: Sep. 7, 2023

(54) Surface Hydration with an Ion Beam

(71) Applicant: Wisconsin Alumni Research Foundation, Madison, WI (US)

(72) Inventors: Joshua Jacques COON, Middleton, WI (US); Michael Scott WESTPHALL, Fitchburg, WI (US)

(21) Appl. No.: 18/178,205

(22) Filed: Mar. 3, 2023

Related U.S. Application Data
(60) Provisional application No. 63/316,823, filed on Mar. 4, 2022.

(51) Int. Cl. H01J 49/16; H01J 49/24; H01J 49/00; H01J 49/04

(52) U.S. Cl. CPC H01J 49/165; H01J 49/164; H01J 49/24; H01J 49/0031; H01J 49/0445; H01J 49/0468

(57) ABSTRACT

Systems and methods for controllably forming an analyte layer comprising amorphous ice and/or other frozen amorphous solids on a substrate. In an embodiment, the present invention provides simplified systems and methods for the preparation of cryo-EM samples, where the same particle beam, such as an ion beam, is used to deposit the desired analyte onto the substrate as well as to generate the amorphous ice or frozen solid layer on the substrate

### CROSS-REFERENCE TO RELATED APPLICATIONS

This application claims priority from U.S. Provisional Patent Application No. 63/316,823, filed Mar. 4, 2022, which is incorporated by reference herein to the extent that there is no inconsistency with the present disclosure.

### STATEMENT REGARDING FEDERALLY SPONSORED RESEARCH OR DEVELOPMENT

This invention was made with government support under GM118110 awarded by the National Institutes of Health. The government has certain rights in the invention.

### BACKGROUND OF THE INVENTION

Single particle cryo-electron microscopy (cryo-EM) is emerging as a powerful alternative for structural studies of eukaryotic cells, proteins (>150 kDa), and macromolecular complexes (e.g., liposomes, organelles, and viruses) (Stark et al., Microscopy, 2016, 65(1):23-34)). Cryo-EM is unique, providing 3D structural information on non-crystalline specimens while also often requiring smaller sample amounts than X-ray crystallography. With the development of a new class of electron detector and advances in software image reconstruction, cryo-EM has approached atomic level resolution, enabling many new biological discoveries. This technology has driven considerable interest, but it still has a number of limitations, including resolution that is still a factor of four less than what is theoretically possible (Glaeser, R. M., Nature Methods, 2016, 13(1):28-32). The majority of limitations are due to sample preparation, which typically requires purification and vitrification. Encasing the sample in vitreous ice (i.e., amorphous ice) helps protect the sample from radiation damage from the electron microscope. Ideal sample vitrification would involve use of an amorphous ice layer, just thick enough to accommodate the particle(s) of interest.

However, in practice, the process of sample vitrification is far from ideal. Typical sample preparation techniques involve solubilization of protein analytes in water followed by pipetting onto a hydrophilic EM grid. The grid is blotted with filter paper (removing >99.99% of the sample) and then plunged into a bath of cryogen, vitrifying the remaining water/sample. A key component to obtaining proper 3D data from EM structures is that the particles must all be of the same structural conformation but randomly oriented within the amorphous ice. Proper 3D analysis is completed via reconstruction of a number of images, thus requiring numerous particles randomly oriented in the same structural conformation. Unfortunately, currently existing sample preparation techniques impart a preferred orientation of the particles (due largely to particle migration to the air/water interface), and the particles often become deformed/stretched at the air-water interface, thereby destroying the required structural heterogeneity. Similar deformations arise from the absorption of the sample to the EM grid substrate. For many cases, the imaged structural heterogeneity does not exist in nature, and without a means of separating the multiple conformations, cryo-EM often cannot be utilized to obtain 3D information (Glaeser, R. M., Nature Methods, 2016, 13(1):28-32; and Yu et al., J. Structural biology, 2014, 187:1-9).

Another requirement of an ideally vitrified specimen is to have a high density of randomly oriented identical molecules located within a hole of the cryo-EM grid. This imposes a significant problem as conventional preparation techniques yield only a very few particles per grid hole. Several factors contribute to this issue. First is that the majority of the sample gets removed during the blotting process. Highly concentrated samples can help compensate for this problem. However, even at the highest concentrations very few particles are observed per grid hole, as they preferentially absorb to the EM-grid, leaving the holes less occupied. Second, formation of ice in conventional methods causes the ice at the center of a hole in the grid to be thinner than the ice near the edges, forcing the particles to the outer edges. This process can also impart a preferred orientation, especially if the molecules are thicker in one dimension than another. With only a few analyte particles per hole, data acquisition times must be extended and data files become very large (i.e., greater than 5 Tb), since much of the EM grid must be imaged to generate sufficient signal for analysis. Beyond limiting the scope and types of proteins that can be analyzed, conventional approaches puts a significant strain on the computational resources required to analyze the data Cheng et al., Cell, 2015, 161(3):438-449).

The present inventors previously disclosed a mass spectrometer-based approach for preparing high quality cryoEM samples (U.S. Pat. No. 11,092,523), where a discrete source (e.g., a molecular beam doser) was used to generate an amorphous ice layer on a sample grid followed by, or performed concurrently with, deposition of an analyte or sample on the grid using the ion beam from a mass spectrometer.

While these methods and systems are very effective, it is desirable to obtain simpler and more efficient cryo-EM sample preparation methods and systems still able to provide high quality samples. Additionally, it is desirable to obtain sample preparation methods for systems for applications other than cryo-EM able to controllably deposit a solvent layer, including but not limited to water, onto a substrate

### SUMMARY OF THE INVENTION

The present invention provides systems and methods for controllably forming an analyte layer comprising amorphous ice and/or other frozen amorphous solids on a substrate, and also provides systems and methods for the preparation of cryo-EM samples.

As discussed above, one aspect of U.S. Pat. No. 11,092,523 describes a system for generating cryo-EM samples using a molecular beam doser to deposit a layer of an amorphous solid on a substrate along with a separate ion beam used to deposit the desired analyte onto the substrate. Preferably, the ion beam is generated using a mass spectrometer. In continuing this line of research, the present inventors discovered that the ion beam often contains a vapor that could be leveraged to generate an amorphous solid layer in addition to being able to deposit the analyte.

Accordingly, in an aspect of the present invention, the same particle beam (i.e., ion beam) is used to deposit the desired analyte onto the substrate as well as to generate the amorphous ice or frozen solid layer on the substrate. For example, in an embodiment the ion beam contains water molecules or molecules of another solvent in addition to the analyte, where the water or other solvent molecules are able to generate amorphous ice on the substrate without needing a separate water or solvent source.

Thus, in an embodiment, the present invention eliminates the need for a separate solvent source (e.g., a molecular beam doser) in the preparation of cryo-EM samples, and simplifies the system thereby reducing the cost to manufacture while also optionally improving sample quality.

In an embodiment, the present invention provides a method for depositing an analyte on a substrate comprising the steps of: a) forming an analyte solution comprising analyte particles and a solvent; b) generating an analyte beam from the analyst solution, where the analyte beam comprises charged or uncharged analyte particles and molecules of the solvent; c) directing the analyte beam toward a substrate surface such that the charged or uncharged analyte particles and molecules of the solvent impinge on the substrate surface. In an embodiment, the substrate surface is at a temperature of 0° C. or less, optionally at a temperature of −25° C. or less, −50° C. or less, −75° C. or less, −100° C. or less, −125° C. or less, −150° C. or less, −175° C. or less, or −195° C. or less. As a result, an amorphous solid layer of the solvent is formed on the surface of the substrate, wherein the charged or uncharged analyte particles are embedded on or within the deposited amorphous solid layer.

In an embodiment, the analyte beam is directed toward the substrate surface at atmospheric pressure or under a vacuum. As used in embodiments described herein, “under a vacuum” refers to a pressure of 10⁻¹ Torr or less, a pressure of 10⁻² Torr or less, a pressure of 10⁻³ Torr or less, a pressure of 10⁻⁴ Torr or less, a pressure of 10⁻⁵ Torr or less, or a pressure of 10⁻⁶ Torr or less. In embodiments, the charged or uncharged analyte particles and molecules of the solvent contact the substrate surface at atmospheric pressure or at a pressure equal to or less than 10⁻¹ Torr, 10⁻² Torr, 10⁻³ Torr, 10⁻⁴ Torr, 10⁻⁵ Torr, or 10⁻⁶ Torr.

In an embodiment, the resulting amorphous solid layer has a thickness of 10 microns or less, preferably 5 microns or less, 2 microns or less, 1 micron or less, 0.5 microns or less, 250 nm or less, 150 nm or less, or 100 nm or less. Optionally, the amorphous solid layer has a uniform thickness which does not vary by more than 10%, preferably by not more than 5%, across the substrate. In an embodiment, the layer of the amorphous solid has an extent of crystallinity less than or equal to 5%, preferably less than or equal to 1%.

Amorphous solids, or non-crystalline solids, refer to solids that lack the long-range molecular order characteristic of crystals. For example, ice formed using the methods and systems described herein is preferably vitreous ice (also referred to herein as amorphous ice). Common H₂O ice is a hexagonal crystalline material where the molecules are regularly arranged in a hexagonal lattice. In contrast, vitreous ice lacks the regularly ordered molecular arrangement. Vitreous ice and the other amorphous solids available with the present invention are produced either by rapid cooling of the liquid phase (so the molecules do not have enough time to form a crystal lattice) or by compressing ordinary ice (or ordinary solid forms) at very low temperatures.

The analyte particles forming the analyte beam can be charged or uncharged particles depending on the deposition method used to deposit the molecules onto the ice layer. Preferably, the analyte particles and the molecules making the amorphous solid layer are substantially randomly orientated when deposited on the substrate, such as on a membrane, film, or EM grid. The analyte beam can be an ion beam, molecular beam, or particle beam. In an embodiment, the analyte particles are ions formed using techniques including, but not limited to, electrospray ionization and laser desorption, such as matrix-assisted laser desorption/ionization (MALDI). Preferably, the analyte particles are ionized under native electrospray conditions so as not to perturb structural conformation of the particles. In a further embodiment, the analyte ions are formed using a mass spectrometer which optionally isolates or purifies the analyte ions. Alternatively, the particle beam is a molecular beam. In a further embodiment, the molecular beam is produced by creating an aerosol of an analyte particle containing solution and introducing the aerosol into the vacuum system.

The analyte particles can be purified or isolated, such as by a mass spectrometer device, before being deposited onto the amorphous solid. Preferably, the analyte beam (including the desired analyte particles and solvent molecules) is characterized by a purity of at least 85%, 90%, 95%, or 99%. For analyte particles, such as proteins, which may have significant conformational structures, it is desirable that the analyte beam is characterized by a conformation purity of at least 85%, 90%, 95% or 99%. For example, it may be desirable to analyze the structure of a particular protein as expressed in a cell. Accordingly, it is necessary to provide a sample, such as an EM sample, where all or most of the protein analyte molecules retain the same conformational structure.

In an embodiment, the analyte beam is generated using a mass spectrometer device, wherein particles having a desired mass range, size range, mass-to-charge-ratio range, or combinations thereof, are optionally isolated or purified from the mixture to generate the analyte beam. Preferably, mass spectrometry analysis is performed on the analyte particles, analyte solution, or both, prior to directing the analyte beam toward the substrate surface. In an embodiment, a mixture of particles is analyzed using the mass spectrometer to identify desired analyte particles within the mixture, wherein particles having a mass range, size range, mass-to-charge-ratio range, or combinations thereof, corresponding to the desired analyte particles are isolated or purified from the mixture to generate the analyte beam. In a further embodiment, the mass spectrometer is used to enrich, reduce, or alter the solvent in the analyte solution to generate the analyte beam. For example, in an embodiment, the amount or composition of the solvent in the analyte solution is modified to generate a predetermined concentration and/or composition. In an embodiment, the optics of the mass spectrometry device are adjusted to remove excess droplets and solvent clusters. Alternatively, such droplets and solvent clusters are preserved.

In an embodiment, particles having a mass within 100 Daltons, preferably 50 Daltons, 20 Daltons, 10 Daltons, 5 Daltons, 2 Daltons, or 1 Dalton to the desired analyte particles are isolated or purified from the mixture to generate the analyte beam. In an embodiment, particles having a mass-to-charge-ratio within 100 m/z, preferably 50 m/z, 25 m/z, 15 m/z, 10 m/z, 5 m/z, 2 m/z, 1.5 m/z, 1 m/z, 0.5 m/z, or 0.1 m/z to the desired analyte particles are isolated or purified from the mixture to generate the analyte beam.

Analyte particles useful with the present invention include, but are not limited to, protein molecules, multi-protein complexes, protein/nucleic acid complexes, nucleic acid molecules, virus particles, micro-organisms, sub-cellular components (e.g., mitochondria, nucleus, Golgi, etc.), and whole cells. In some embodiments, the analyte particles are molecular entities, single molecules, or multiple molecules complexed together through non-covalent interactions (such as hydrogen bonds or ionic bonds). In embodiments, the analyte particles have a molecular mass exceeding 500 Daltons, 1,000 Daltons, 5,000 Daltons, 10,000 Daltons, 25,000 Daltons, 50,000 Daltons, 75,000 Daltons, 100,000 Daltons, or 150,000 Daltons.

In certain embodiments, the analyte beam is characterized by an intensity selected from the range of 0.025 to 25 particles per 1 μm² per second, 0.05 to 10 particles per 1 μm² per second, or 0.1 to 5 particles per 1 μm² per second. In certain embodiments, the analyte beam is characterized by a spot size selected from the range of 800 μm² to 3.8E7 μm².

In embodiments described herein, the solvent can comprise any molecules or atoms able to form amorphous solids where exposed to low temperatures and pressures. Such solvents include, but are not limited to, cyclohexanol, methanol, ethanol, isopentane, water, O₂, Si, SiO₂, S, C, Ge, Fe, Co, Bi and mixtures thereof. Preferably, the solvent is water and the amorphous solid is amorphous ice.

In an embodiment, the analyte particles are ions and the analyte source is able to generate a controllable ion beam containing charged analyte ions (such as electrospray ion deposition) and direct the ion beam to contact the receiving surface of the cryo-EM probe. In a further embodiment, the system further comprises a modified mass spectrometer that can provide purified ions to the analyte source. In another embodiment, the system comprises an electron microscope where the cryo-EM probe is directly transferred from the deposition portion of the instrument to the microscope portion of the instrument for analysis.

In an embodiment, the present invention provides sample preparation system comprising: a) a vacuum chamber or gas chamber; b) a substrate positioned with the vacuum chamber or gas chamber, wherein said substrate comprises a receiving surface; c) a temperature control means able to provide a temperature of 0° C. or less to the receiving surface of the substrate; and d) an analyte source in fluid communication with the vacuum chamber or gas chamber, wherein the analyte source is able to produce a controllable analyte beam comprising charged or uncharged analyte particles and molecules of a solvent, and direct said analyte beam to contact the receiving surface of the substrate. Preferably, the analyte beam is generated using a mass spectrometer. Optionally, the vacuum chamber or gas chamber is a gas chamber able to provide atmospheric pressure. Alternatively, the vacuum chamber or gas chamber is a vacuum chamber able to provide a pressure of 10⁻¹ Torr, a pressure of 10⁻² Torr, a pressure of 10⁻³ Torr, a pressure of 10⁻⁴ Torr, a pressure of 10⁻⁵ Torr, or a pressure of 10⁻⁶ Torr. Optionally, the temperature control means is able to provide a temperature of −25° C. or less, −50° C. or less, −75° C. or less, −100° C. or less, −125° C. or less, −150° C. or less, −175° C. or less, or −195° C. or less −150° C. or less, −175° C. or less, or −195° C. or less. Devices and methods for providing a vacuum chamber, gas chamber, or other kind of surface at cryogenic temperatures are well known in the art. For example, in an embodiment, the temperature control means comprises a cold finger able to provide localized temperature control of the receiving surface of the substrate.

In an embodiment, the system is a cryo-electron microscopy (cryo-EM) system and the substrate is part of a cryo-EM probe. Preferably, the system comprises or forms part of a modified mass spectrometer able to provide ions and molecules of the solvent to the analyte source.

Optionally, the substrate described in the embodiments provided herein is an electron microscopy (EM) grid as known in the art. The EM grid may comprise a metal, including but not limited to copper, rhodium, nickel, molybdenum, titanium, stainless steel, aluminum, gold, or combinations thereof as known in the art. Additionally, the EM grid may comprise a continuous film or membrane which is positioned across the top or bottom surface of the grid, or within the holes of the grid, so as to provide a solid support for the formation of the amorphous solid. Preferably, the EM grid is covered by a thin film or membrane which includes, but is not limited to, films and membranes comprising graphene, graphene oxide, silicon oxide, silicon nitride, carbon, and combinations thereof. With a grid that does not contain a film or membrane, the molecular beam intended to form the amorphous solid may pass through at least a portion of the holes in the grid without producing a suitable layer. The film or membrane should be thin enough so as to not scatter electrons. Preferably, the film or membrane has an approximate thickness or 15 nm or less, 10 nm or less, 5 nm or less, 2 nm or less, or 1 nm or less. In an embodiment, the substrate is an EM grid comprising a graphene or graphene oxide monolayer film or membrane positioned across the surface of the grid.

### BRIEF DESCRIPTION OF THE DRAWINGS

FIG. 1 mass spectrum obtained by analyzing apoferritin ions landed onto a cryogenically cooled electron microscope grid using an ion beam containing residual water. A cluster of m/z peaks is present centered at 9,065 m/z. This corresponds to the ˜60 charge state of the apoferritin complex. The width of these m/z peaks suggests that some residual water molecules are likely remaining on the apoferritin ions.

FIG. 2 shows a mass spectrum using the same ion beam as FIG. 1, but after using a quadrupole mass filter to filter for ions having an m/z value between ˜9,000 and 10,000.

FIG. 3 shows an EM image of a grid hole of an electron microscope grid treated with the unfiltered beam utilized in FIG. 1. A layer of amorphous ice has formed, but no apoferritin can be visualized, likely because the ice is too thick to allow its observation.

FIG. 4 shows an EM image of a grid hole of an electron microscope grid treated with the filtered beam utilized in FIG. 2. Particles can be seen that are most likely one or two apoferritin subunits given that they are too small to be the intact complex.

FIG. 5 shows EM images of a carbon TEM grid cooled to −190° C. and treated with an ion beam containing GroEL proteins and residual water. The grid was removed from the chamber and negative stained. A layer of amorphous ice has formed, and GroEL particles can be seen gathered together in small pools or groups.

FIG. 6 shows a cryo-electron microscopy (cryo-EM) sample preparation system in an embodiment of the present invention.

FIG. 7 shows an ion analyte source used in an embodiment of the invention, where the analyte source comprises ions optics (such as and skimmers) to focus and direct an ion beam.

### DETAILED DESCRIPTION OF THE INVENTION

Ion beams are routinely generated for many applications including mass spectrometry. In mass spectrometry ion beams can be made in a variety of ways, perhaps the most prevalent being electrospray ionization (ESI). In ESI, analytes are diluted in solutions that typically contain some fraction of water or another solvent. This solution is then placed in a needle or capillary and an electric field applied. The application of an electric field and flow of the solution, either forced or induced by the field as in static nanospray, results in the formation of a plume of charged droplets. These charged droplets can be directed towards and into the inlet of a mass spectrometer. During their transfer and passage into the mass spectrometer inlet and into the vacuum system of the mass spectrometer, they continue to undergo desolvation and evaporation such that a beam containing charged analyte ions is created. These ions are then manipulated in various ways using the techniques of mass spectrometry.

The present study discovered that ion beams generated in this way also contain significant amounts of water or other solvents. The water or other solvent molecules sometimes remain attached to the analyte ion to form a solvent-analyte ion complex, such as a water-analyte ion complex. In conventional systems, techniques are typically used to ensure removal of the water so as to allow for the precise measurement of the analyte's mass. Water-containing ionic clusters that are devoid of analyte also exist. Often background signals are observed in mass spectra that might be attributed to such species, but, because their mass-to-charge values likely span a broad range on account of a highly varied distribution of sizes, these water-containing ionic clusters are often not observed in mass spectra. In certain embodiments, the optics of the mass spectrometry device may be adjusted to remove excess droplets and solvent clusters. Alternatively, such droplets and solvent clusters may be preserved.

### Example 1—Surface Hydration with an Ion Beam

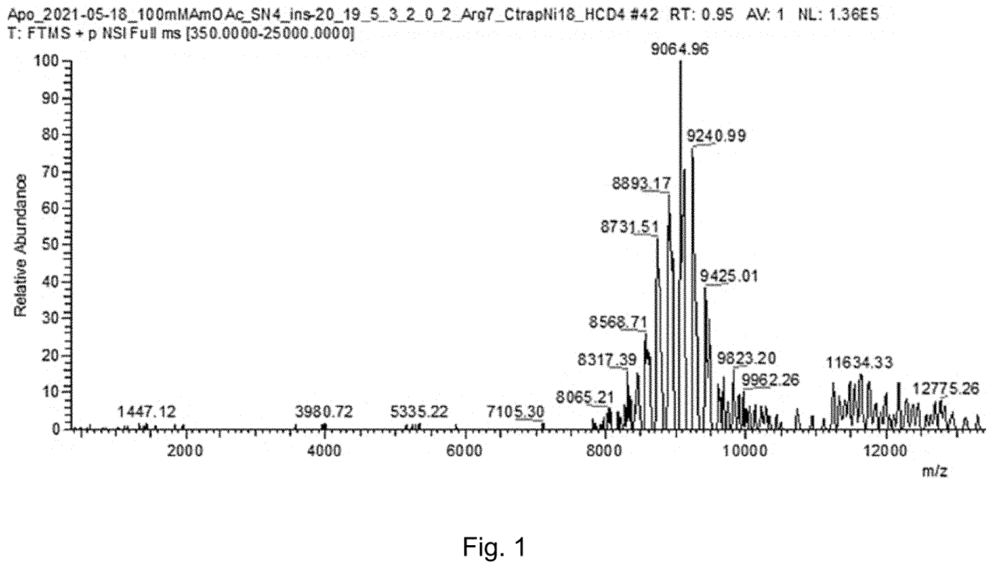

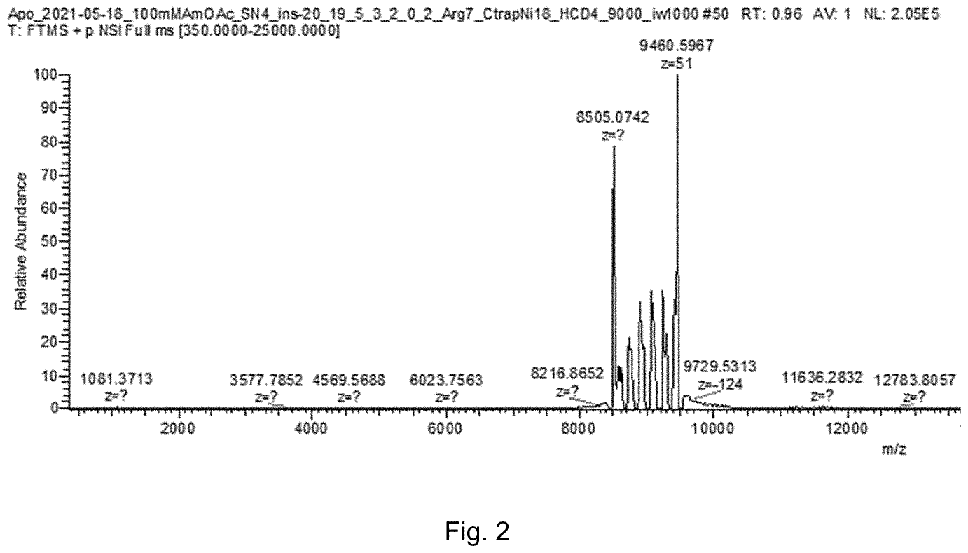

In an example, a modified mass spectrometer was used to land an ion beam onto a cryogenically cooled electron microscope grid. The ion beam was generated following electrospray of an aqueous solution of protein complex apoferritin. The mass spectrum obtained by analyzing the resultant ions in an Orbitrap mass spectrometer are shown in FIG. 1, where there is a cluster of m/z peaks centered at 9,065 m/z. This corresponds to the ˜60 charge state of the apoferritin complex. The width of these m/z peaks suggests that some residual water molecules are likely remaining on the apoferritin ions. The mass spectrum in FIG. 2 shows the same ion beam but after a quadrupole mass filter has been used to allow ions having an m/z value between 9,000 and 10,000 pass.

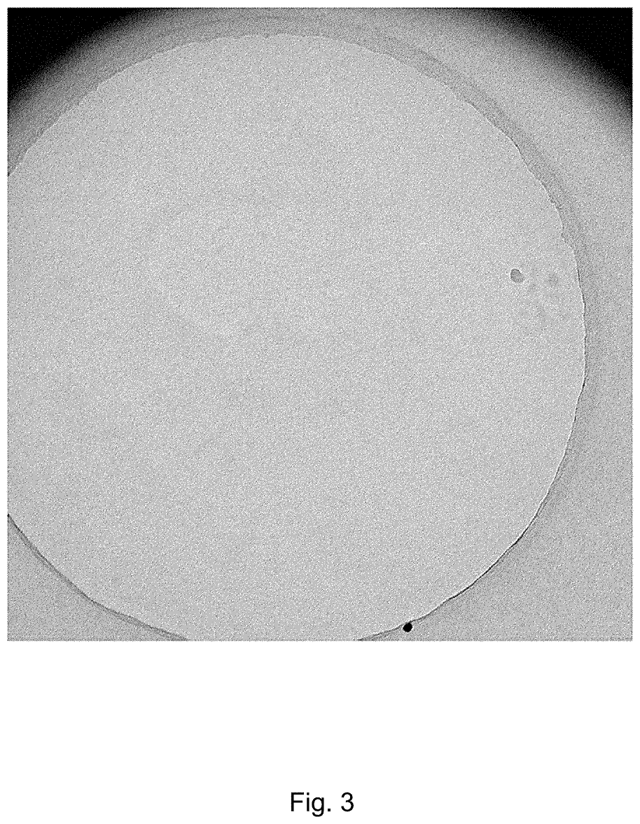

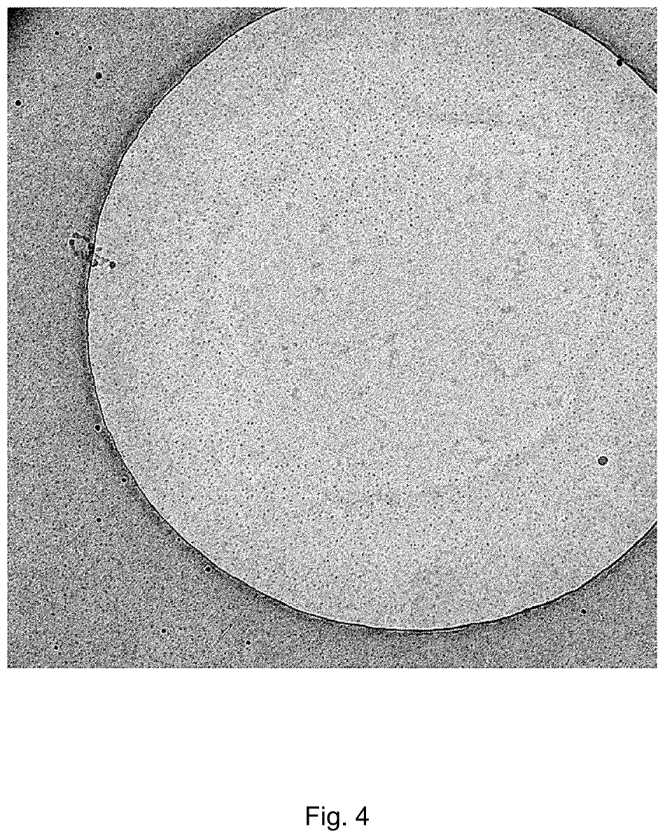

To understand the makeup of the ion beam that produced the spectra shown in FIGS. 1 and 2, the unfiltered beam was diverted to the cryo-cooled EM grid. The image on in FIG. 3 shows a close-up of one of the grid holes, where a layer of amorphous ice has formed. No apoferritin can be visualized—likely because the ice is too thick to allow its observation. FIG. 4 shows an image when the filtered beam (lower mass spectrum) is directed toward the surface. Here, particles can be seen that are most likely one or two apoferritin subunits given that they are too small to be the intact complex.

Exposure to radiation causes damage to the particles, which is expected behavior for proteins. Also notice the ring in the center of the image. This ring provides evidence that for a time liquid water was present prior to freezing. The ice thickness on the filtered ion beam is much thinner than that observed on the unfiltered ion beam.

These data provide direct evidence that a substantial component of the ion beam comprises water—in water-containing ionic clusters and/or attached to analyte ion clusters. This water contained in an ion beam, which has not been documented to such an extent before, can be used in the present invention to have practical purposes. In particular, the water or other solvent contained in the ion beam can be used to hydrate a surface, or otherwise apply the solvent to a surface. Such surface hydration can provide protection to radiation sensitive particles or samples that are also on the surface, including particles and samples derived from the same ion beam.

In a further example, a modified mass spectrometer was used to treat a cryogenically cooled electron microscope grid with an ion beam generated following the electrospray of an aqueous solution of GroEL, a bacterial chaperonin protein.

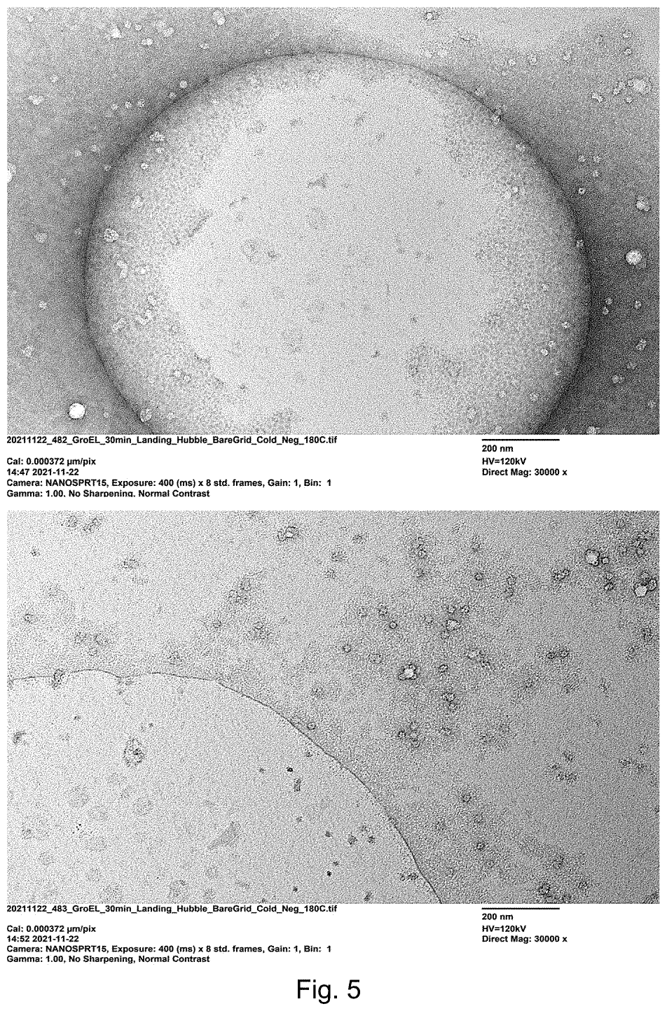

A carbon TEM grid was cooled to −190 degrees Celsius and the ion beam was used to soft land GroEL proteins onto the grid for a period of 30 minutes. While keeping the grid at −190, the pressure in the vacuum chamber was raised to atmospheric pressure. Once up to pressure, the grid was warmed to room temperature, 22 degrees Celsius (still in a helium environment). The warming time, with the assistance of a resistive thermal heater, was ten minutes. The grid was then removed from the chamber and negative stained. FIG. 5 shows two images which show that some of the GroEL survived and appeared to gather in small pools. Thus, these experiments illustrate that landing bioparticles on a cryogenic surface can preserve molecules using a single ion beam without the use of additional other sources of water or other solvents.

### Example 2—Cryo-EM Sample Preparation Instrument

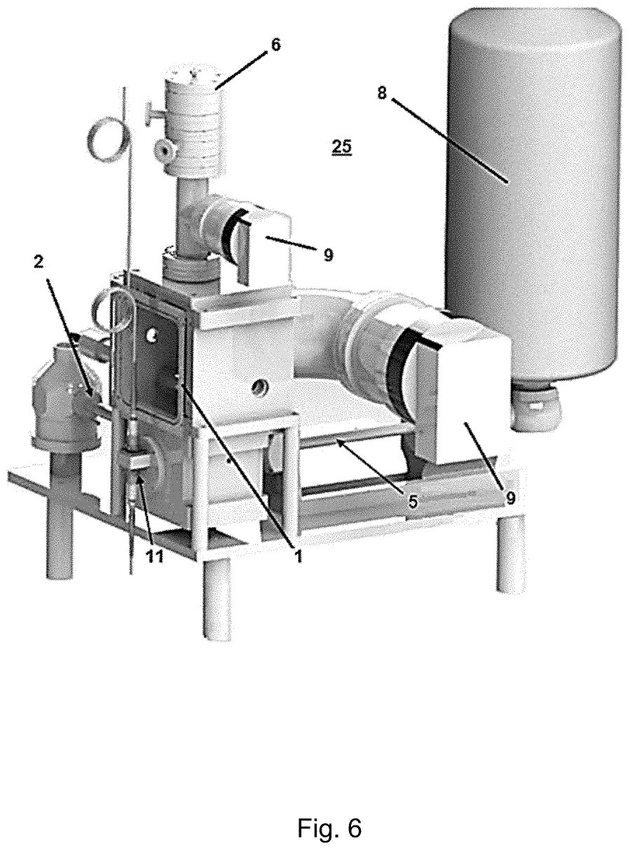

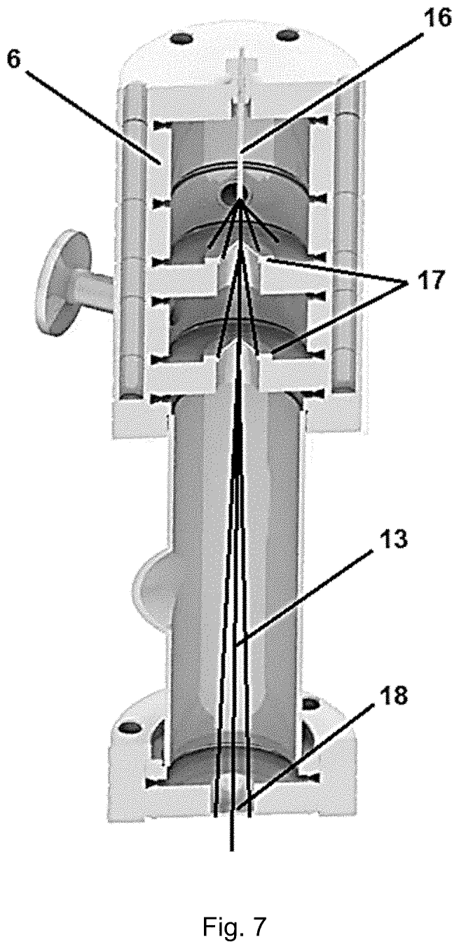

FIGS. 6 and 7 show an exemplary cryo-electron microscopy (cryo-EM) sample preparation systems 25 according to certain embodiments of the present invention where the analyte beam is used to deposit the analyte particles and amorphous solid layer. A cryo-EM probe 2 able to hold or contain a sample is inserted into vacuum chamber 1 (or gas chamber). The temperature of the system is maintained using a coolant, such as liquid nitrogen, which is stored in tank 8 and transferred through cold finger 5, while one or more turbo pumps 9 are used to maintain the vacuum.

Analyte particles and molecules of the solvent, typically in the form of a vapor, are collected in an analyte source 6 where they are focused into an analyte beam 13 (such as through electrospray ion deposition) and directed to contact the sample plate being held by cryo-EM probe 2. FIG. 7 shows one type of an analyte source 6 where analyte particles and solvent molecules are drawn into the analyte source 6 through capillary 16. One or more ion optic devices, such as skimmers 17, are used to focus the analyte ions and solvent molecules into a beam 13 and to control the release speed of the ions and molecules through exit aperture 18. An optical detection cell 11 can be used to monitor whether the deposited ice layer comprises vitreous ice or crystalline ice.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

When a group of materials, compositions, components or compounds is disclosed herein, it is understood that all individual members of those groups and all subgroups thereof are disclosed separately. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. Additionally, the end points in a given range are to be included within the range. In the disclosure and the claims, “and/or” means additionally or alternatively. Moreover, any use of a term in the singular also encompasses plural forms.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements.

One of ordinary skill in the art will appreciate that starting materials, device elements, analytical methods, mixtures and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. The invention illustratively described herein suitably may be practiced in the absence of any element or elements, limitation or limitations which is not specifically disclosed herein. Headings are used herein for convenience only.

All publications referred to herein are incorporated herein to the extent not inconsistent herewith. Some references provided herein are incorporated by reference to provide details of additional uses of the invention. All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art.

1. A method for depositing an analyte on a substrate comprising the steps of:
a) forming an analyte solution comprising analyte particles and a solvent;
b) generating an analyte beam from the analyte solution, where the analyte beam comprises charged or uncharged analyte particles and molecules of the solvent;
c) directing the analyte beam toward a substrate surface at atmospheric pressure or under a vacuum such that the charged or uncharged analyte particles and molecules of the solvent impinge on the substrate surface,
wherein the substrate surface is at a temperature of 0° C. or less thereby forming an amorphous solid layer of the solvent on the substrate surface,
wherein the amorphous solid layer has a thickness of 10 microns or less, and wherein the charged or uncharged analyte particles are embedded within the deposited amorphous solid layer.

2. The method of claim 1, wherein the substrate surface is at a temperature of −100° C. or less.

3. The method of claim 1, wherein the analyte beam is an ion beam formed using electrospray ionization (ESI) or laser desorption.

4. The method of claim 1, wherein the solvent comprises cyclohexanol, methanol, ethanol, isopentane, water, O₂, Si, SiO₂, S, C, Ge, Fe, Co, Bi, and combinations thereof.

5. The method of claim 1, wherein the solvent is water.

6. The method of claim 1, wherein the substrate is an electron microscopy (EM) grid comprising a continuous film or membrane positioned across a top or bottom surface of the EM grid.

7. The method of claim 1, wherein the analyte beam is directed toward the substrate surface under vacuum, wherein the charged or uncharged analyte particles and molecules of the solvent contact the substrate surface at a pressure equal to or less than 10⁻¹ Torr.

8. The method of claim 7, wherein the charged or uncharged analyte particles and molecules of the solvent contact the substrate surface at a pressure equal to or less than 10⁻³ Torr.

9. The method of claim 1, wherein the amorphous solid layer has a thickness of 5 microns or less.

10. The method of claim 17, wherein the analyte beam is generated using a mass spectrometer device, wherein generating an analyte beam comprises performing mass spectrometry analysis on a mixture of particles, identifying desired analyte particles within the mixture, and isolating the desired analyte particles from the mixture based on the mass, size, mass-to-charge ratio, or combinations thereof, of the desired analyte particles.

11. The method of claim 10, wherein generating an analyte beam comprises isolating particles having a mass-to-charge-ratio within 2 m/z to the desired analyte particles.

12. The method of claim 10 further comprising enriching, reducing, or altering the solvent in the analyte solution to generate the analyte beam.

13. A sample preparation system comprising:
a) a vacuum chamber or gas chamber;
b) a substrate positioned with the vacuum chamber or gas chamber, wherein said substrate comprises a receiving surface;
c) a temperature control means able to provide a temperature of 0° C. or less to the receiving surface of the substrate; and
d) an analyte source in fluid communication with the vacuum chamber or gas chamber, wherein the analyte source is able to produce a controllable analyte beam comprising charged or uncharged analyte particles and molecules of a solvent, and direct said analyte beam to contact the receiving surface of the substrate.

14. The system of claim 13, wherein the analyte source is able to generate an ion beam using electrospray ionization (ESI) or laser desorption.

15. The system of claim 13, wherein the temperature control means is able to provide a temperature of −100° C. or less to the receiving surface of the substrate.

16. The system of claim 13, wherein the system is a cryo-electron microscopy (cryo-EM) system and the substrate is part of a cryo-EM probe.

17. The system of claim 13 further comprising a modified mass spectrometer device able to provide ions and molecules of the solvent to the analyte source.

18. The system of claim 17, wherein the modified mass spectrometer device is able to isolate particles in a mixture, wherein the isolate particles have a mass-to-charge-ratio within 2 m/z to preselected desired analyte particles, and wherein the modified mass spectrometer device is able to perform mass spectrometry analysis on the isolated particles.

19. The system of claim 13, wherein the vacuum chamber or gas chamber is a vacuum chamber able to provide a pressure equal to or less than 10⁻¹ Torr.

20. The system of claim 13, wherein the vacuum chamber or gas chamber is a vacuum chamber able to provide a pressure equal to or less than 10⁻³ Torr.
